(19) United States
(12) Patent Application Publication
(10) Pub. No.: US 2025/0252755 A1
(43) Pub. Date: Aug. 7, 2025

(54) EXTERNAL ENVIRONMENT RECOGNITION APPARATUS

(71) Applicant: Honda Motor Co., Ltd., Tokyo (JP)

(72) Inventors: Shunsuke Konishi, Wako-shi (JP); Ryota Okutsu, Tokyo (JP); Shuhei Masuoka, Utsunomiya-shi (JP)

(21) Appl. No.: 19/042,660

(22) Filed: Jan. 31, 2025

(30) Foreign Application Priority Data
Feb. 5, 2024 (JP) 2024-015360

(51) Int. Cl. G06V 20/58; G01S 17/89; G01S 17/931

(52) U.S. Cl. CPC G06V 20/58; G01S 17/89; G01S 17/931

(57) ABSTRACT

An external environment recognition apparatus includes: an in-vehicle detection unit configured to acquire point cloud data of an object around the subject vehicle; and a microprocessor. The microprocessor is configured to perform: recognizing a object based on the point cloud data; determining a first angular resolution in a vertical direction based on a size in the vertical direction of a first object on a road apart from the subject vehicle by a first distance based on a vehicle speed; determining a second angular resolution in the vertical direction based on a size in the vertical direction of a second object located at a predetermined height from a road surface apart from the subject vehicle by a second distance; and controlling the in-vehicle detection unit with the first angular resolution or the second angular resolution for each angle in the vertical direction.

### CROSS-REFERENCE TO RELATED APPLICATION

This application is based upon and claims the benefit of priority from Japanese Patent Application No. 2024-015360 filed on Feb. 5, 2024, the content of which is incorporated herein by reference.

### BACKGROUND

### Technical Field

The present invention relates to an external environment recognition apparatus for recognizing an external environment situation of a vehicle.

### Related Art

As a device of this type, there is known a device for changing emission angles of laser light emitted from a LiDAR about a first axis parallel to a height direction and a second axis parallel to a horizontal direction, performing scanning, and detecting an external environment of a vehicle on the basis of position information of each detection point (for example, see JP 2020-149079 A).

In the above device, many detection points are acquired by scanning, and a processing load for acquiring the position information based on each detection point is large.

Detecting the external environment situation of the vehicle enables smooth movement of the vehicle, thereby leading to improvement in traffic convenience and safety. This enables a contribution to development of a sustainable transportation system.

### SUMMARY

An aspect of the present invention is an external environment recognition apparatus including: an in-vehicle detection unit configured to scan and emit electromagnetic waves in a horizontal direction and a vertical direction to acquire point cloud data including three-dimensional position information of detection points on a surface of an object based on a reflected wave from the object around the subject vehicle frame by frame; and a microprocessor. The microprocessor is configured to perform: recognizing a three-dimensional object on a road on which the subject vehicle travels as external environment information based on the point cloud data for each frame; determining an interval between detection points in the vertical direction of the point cloud data of a next frame as a first angular resolution in the vertical direction for scanning and emitting the electromagnetic waves based on a size in the vertical direction of a first three-dimensional object determined in advance as a detection target on a road apart from the subject vehicle by a first distance based on a vehicle speed of the subject vehicle; determining the interval between the detection points in the vertical direction of the point cloud data of the next frame as a second angular resolution in the vertical direction for scanning and emitting the electromagnetic waves based on a size in the vertical direction of a second three-dimensional object determined in advance as a detection target located at a predetermined height from a road surface apart from the subject vehicle by a second distance; and controlling scanning and emission of the in-vehicle detection unit with the interval between detection points in the vertical direction of the point cloud data of the next frame as the first angular resolution or the second angular resolution for each angle in the vertical direction.

### BRIEF DESCRIPTION OF DRAWINGS

The objects, features, and advantages of the present invention will become clearer from the following description of embodiments in relation to the attached drawings, in which:

FIG. 1A is a diagram illustrating how a vehicle drives on a road;

FIG. 1B is a schematic diagram illustrating an example of detection data obtained by a LiDAR;

FIG. 2 is a block diagram illustrating a configuration of a main part of a vehicle control device;

FIG. 3A is a diagram illustrating a position of point cloud data in a three-dimensional space using a three-dimensional coordinate system;

FIG. 3B is a diagram describing mapping of the point cloud data from the three-dimensional space to a two-dimensional X-Z space;

FIG. 3C is a schematic diagram illustrating the point cloud data divided for each grid;

FIG. 3D is a schematic diagram illustrating a road surface gradient in a depth distance direction;

FIG. 4A is a schematic diagram illustrating a light projection angle and the depth distance;

FIG. 4B is a schematic diagram illustrating the distance measured by the LiDAR;

FIG. 5A is a schematic diagram illustrating an example of a relationship between the depth distance and the light projection angle in a vertical direction;

FIG. 5B is a schematic diagram illustrating an example of a relationship between the depth distance and an angular resolution in the vertical direction;

FIG. 6A is a schematic diagram illustrating an example of irradiation points in a case where an irradiation light of the LiDAR is emitted in a raster scanning method;

FIG. 6B is a schematic diagram illustrating an example of irradiation points in a case where the irradiation light of the LiDAR is emitted only on predetermined irradiation points arranged in a lattice pattern in a detection area;

FIG. 7 is a diagram illustrating an example of an irradiation order in a case where the irradiation points illustrated in FIG. 6B are irradiated with the irradiation light;

FIG. 8A is a schematic diagram illustrating a range in which a traffic light as a second three-dimensional object;

FIG. 8B is a diagram illustrating an example of a size of traffic light;

FIG. 9A is a schematic diagram illustrating an example of a relationship between the depth distance and the light projection angle in the vertical direction with respect to the position on the boundary line in FIG. 8A;

FIG. 9B is a schematic diagram illustrating an example of a relationship between the depth distance and the angular resolution in the vertical direction;

FIG. 10 is a diagram illustrating a prediction result, of road surface gradient;

FIG. 11A is a flowchart illustrating an example of processing executed by the CPU of the controller in FIG. 2;

FIG. 11B is a flowchart illustrating the example of processing executed by the CPU of the controller in FIG. 2; and

FIG. 12 is a flowchart for describing details of a processing of step S20 in FIG. 11A.

### DETAILED DESCRIPTION OF THE INVENTION

Hereinafter, an embodiment of the invention will be described with reference to the drawings.

An external environment recognition apparatus according to the embodiment of the invention is applicable to a vehicle having a self-driving capability, that is, a self-driving vehicle. Note that a vehicle to which the external environment recognition apparatus according to the present embodiment is applied is referred to as a subject vehicle in some cases so as to be distinguished from other vehicles. The subject vehicle may be any of an engine vehicle including an internal combustion engine (engine) as a traveling drive source, an electric vehicle including a traveling motor as the traveling drive source, and a hybrid vehicle including an engine and a traveling motor as the traveling drive sources. The subject vehicle is capable of driving not only in a self-drive mode that does not require a driver's driving operation but also in a manual drive mode that requires a driver's driving operation.

While a self-driving vehicle is traveling in the self-drive mode (hereinafter, referred to as self-driving or autonomous driving), the self-driving vehicle recognizes an external environment situation in the surroundings of the subject vehicle based on detection data of an in-vehicle detection unit such as a camera or a light detection and ranging (LiDAR). The self-driving vehicle generates a driving path (a target path) after a predetermined time from the current point in time based on the recognition result, and controls an actuator for traveling so that the subject vehicle travels along the target path.

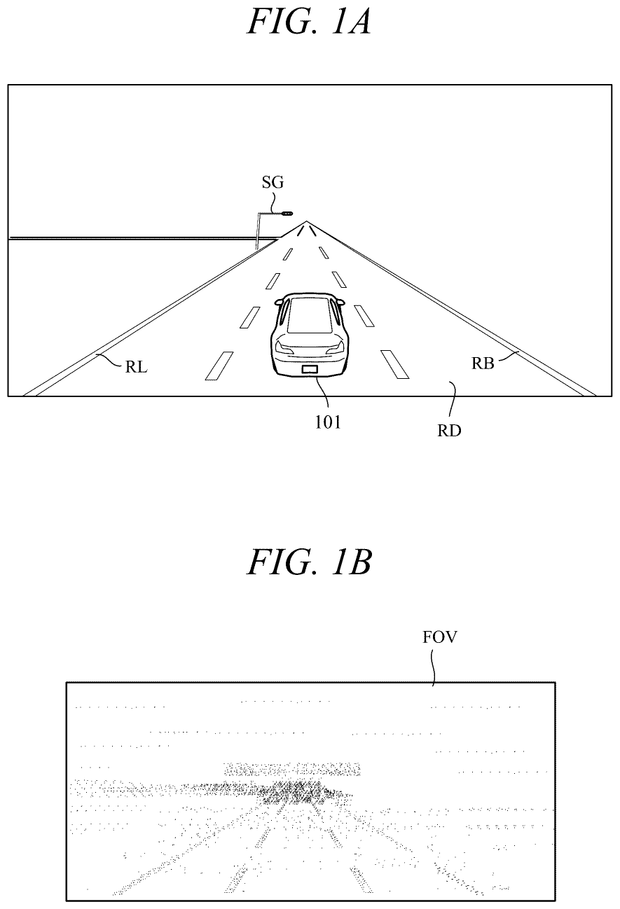

FIG. 1A is a diagram illustrating how a subject vehicle 101, which is a self-driving vehicle, drives on a road RD. A traffic light SG is provided at a T-junction at the center of the screen. FIG. 1B is a schematic diagram illustrating an example of detection data obtained by a LiDAR mounted on the subject vehicle 101 and directed in an advancing direction of the subject vehicle 101. A measurement point (which can also be referred to as a detection point) by the LiDAR is point information of the emitted laser light that has been reflected by a certain one point on a surface of an object and then returned. The point information includes at least the distance from the laser source to the point and the intensity of the laser light reflected and returned. In addition, data including a plurality of detection points as illustrated in FIG. 1B will be referred to as point cloud data. FIG. 1B illustrates point cloud data based on detection points of surfaces of objects included in the field of view (hereinafter referred to as FOV) of the LiDAR among the objects in FIG. 1A. The FOV may be, for example, 120 deg in a horizontal direction (which may be referred to as a road width direction) and 40 deg in a vertical direction (which may be referred to as an up-down direction) of the subject vehicle 101. The value of the FOV may be appropriately changed based on the specifications of the external environment recognition apparatus. The subject vehicle 101 recognizes an external environment situation around the vehicle, more specifically, a road structure, an object, and the like around the vehicle, based on the point cloud data as illustrated in FIG. 1B, and generates a target path based on the recognition result.

Incidentally, as a method for sufficiently recognizing the external environment situation around the vehicle, it is conceivable to increase the number of irradiation points of electromagnetic waves emitted from the in-vehicle detection unit such as a LiDAR (in other words, to increase the density of irradiation points of electromagnetic waves so as to increase the number of detection points constituting point cloud data). On the other hand, in a case where the number of irradiation points of electromagnetic waves is increased (the number of detection points is increased), there is a possibility that a processing load for controlling the in-vehicle detection unit increases, an amount of detection data (point cloud data) obtained by the in-vehicle detection unit increases, resulting in an increase in processing load for the point cloud data. In particular, in a situation where there are many objects on the road or beside the road, the amount of point cloud data further increases.

Therefore, in consideration of the above points, in the embodiment, the external environment recognition apparatus described below is configured.

### Overview

The external environment recognition apparatus according to the embodiment intermittently emits irradiation light as an example of electromagnetic waves in the advancing direction of the subject vehicle 101 from the LiDAR of the subject vehicle 101 traveling on the road RD, and acquires point cloud data at different positions on the road RD in a discrete manner. The irradiation range of the irradiation light emitted from the LiDAR is set such that a blank section of data is not generated in the advancing direction of the road RD in the point cloud data of a previous frame that has been acquired by the LiDAR by the previous irradiation and the point cloud data of a next frame to be acquired by the LiDAR by the current irradiation.

By setting the detection point density in the irradiation range, for example, to be higher for a road surface far from the subject vehicle 101 and to be lower for a road surface closer to the subject vehicle 101, the total number of detection points for use in recognition processing is reduced as compared with that in a case where the detection point density is set to be high for the entire road surface in the irradiation range. As a result, it is possible to reduce the number of detection points for use in recognition processing without deteriorating accuracy in recognizing a position (a distance from the subject vehicle 101) or a size of an object or the like recognized based on the point cloud data. In addition, it is also possible to make the LiDAR small and inexpensive, such as reducing the number of laser elements included in the LiDAR.

Such an external environment recognition apparatus will be described in more detail.

### <Configuration of Vehicle Control Device>

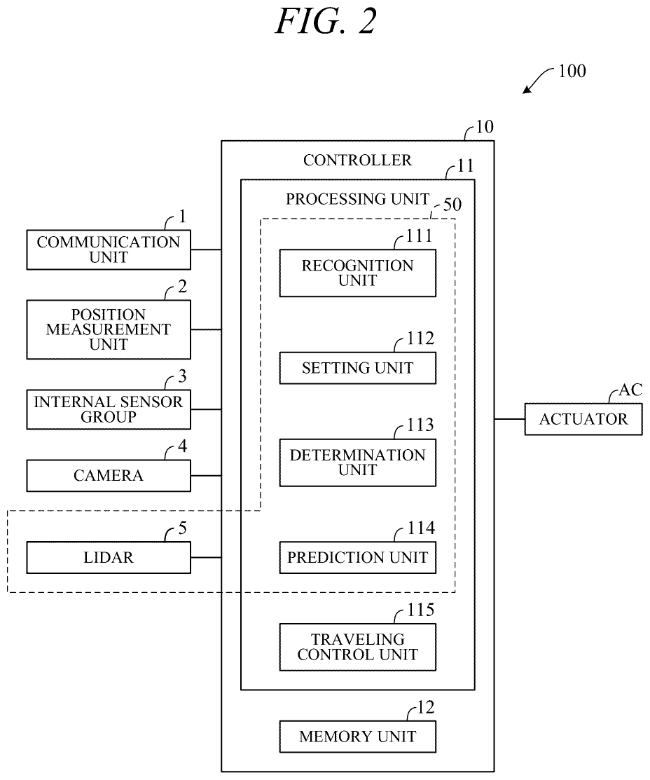

FIG. 2 is a block diagram illustrating a configuration of a main part of a vehicle control device 100 including an external environment recognition apparatus. The vehicle control device 100 includes a controller 10, a communication unit 1, a position measurement unit 2, an internal sensor group 3, a camera 4, a LiDAR 5, and an actuator AC for traveling. In addition, the vehicle control device 100 includes an external environment recognition apparatus 50, which constitutes a part of the vehicle control device 100. The external environment recognition apparatus 50 recognizes an external environment situation around the vehicle based on detection data of the in-vehicle detection unit such as the camera 4 or the LiDAR 5.

The communication unit 1 communicates with various servers, which are not illustrated, through a network including a wireless communication network represented by the Internet network, a mobile phone network, or the like, and acquires map information, traveling history information, traffic information, and the like from the servers periodically or at a certain timing. The network includes not only a public wireless communication network but also a closed communication network provided for each predetermined management area, for example, a wireless LAN, Wi-Fi (registered trademark), Bluetooth (registered trademark), or the like. The acquired map information is output to a memory unit 12, and the map information is updated. The position measurement unit (GNSS unit) 2 includes a position measurement sensor that receives a position measurement signal transmitted from a position measurement satellite. The position measurement satellite is an artificial satellite such as a GPS satellite or a quasi-zenith satellite. By using the position measurement information received by the position measurement sensor, the position measurement unit 2 measures a current position (latitude, longitude, and altitude) of the subject vehicle 101.

The internal sensor group 3 is a general term for a plurality of sensors (internal sensors) that detects a traveling state of the subject vehicle 101. For example, the internal sensor group 3 includes a vehicle speed sensor that detects a vehicle speed (a traveling speed) of the subject vehicle 101, an acceleration sensor that detects an acceleration in a front-rear direction and an acceleration (lateral acceleration) in a left-right direction of the subject vehicle 101, a rotation rate sensor that detects a rotation rate of the traveling drive source, a yaw rate sensor that detects a rotation angular speed about a vertical axis at the center of gravity of the subject vehicle 101, and the like. The internal sensor group 3 also includes a sensor that detects a driver's driving operation in the manual drive mode, for example, an operation of an accelerator pedal, an operation of a brake pedal, or an operation of a steering wheel.

The camera 4 includes an imaging element such as a CCD or a CMOS, and captures images of the surroundings (forward, rearward, and sideward) of the subject vehicle 101. The LiDAR 5 receives scattered light with respect to the irradiation light, and measures a distance from the subject vehicle 101 to a surrounding object, a position and shape of the object, and the like.

The actuator AC is an actuator for traveling for controlling the traveling of the subject vehicle 101. In a case where the traveling drive source is an engine, the actuator AC includes a throttle actuator that adjusts an opening degree (a throttle opening degree) of a throttle valve of the engine. In a case where the traveling drive source is a traveling motor, the traveling motor is included in the actuator AC. The actuator AC also includes a braking actuator that operates a braking device of the subject vehicle 101, and a steering actuator that drives a steering device.

The controller 10 includes an electronic control unit (ECU). More specifically, the controller 10 is configured to include a computer including a processing unit 11 such as a CPU (microprocessor), the memory unit 12 such as ROM and RAM, and other peripheral circuits, which are not illustrated, such as an I/O interface. Note that, although a plurality of ECUs having different functions such as an ECU for controlling the engine, an ECU for controlling the traveling motor, and an ECU for the braking device can be individually provided, it is illustrated in FIG. 2 for the sake of convenience that the controller 10 is illustrated as a set of these ECUs.

The memory unit 12 can store highly precise detailed map information (referred to as high-precision map information). The high-precision map information includes position information of roads, information of road shapes (curvatures or the like), information of road gradients, position information of intersections and branch points, information of the number of traffic lanes (traveling lanes), traffic lane widths and position information for each traffic lane (information of center positions of traffic lanes or boundary lines of traffic lane positions), position information of landmarks (traffic lights, traffic signs, buildings, and the like) as marks on a map, and information of road surface profiles such as irregularities of road surfaces. In addition, other than two-dimensional map information to be described below, the memory unit 12 can also store programs for various types of control, information of thresholds for use in programs, or the like, and setting information (irradiation point information to be described below, and the like) for the in-vehicle detection unit such as the LiDAR 5.

Note that highly precise detailed map information is not necessarily needed in the embodiment, and the detailed map information may not be stored in the memory unit 12.

The processing unit 11 includes a recognition unit 111, a setting unit 112, a determination unit 113, a prediction unit 114, and a driving control unit 115, as functional configurations. Note that, as illustrated in FIG. 2, the recognition unit 111, the setting unit 112, the determination unit 113, and the prediction unit 114 are included in the external environment recognition apparatus 50. As described above, the external environment recognition apparatus 50 recognizes an external environment situation around the vehicle on the basis of the detection data of the in-vehicle detection unit such as the camera 4 or the LiDAR 5. Details of the recognition unit 111, the setting unit 112, the determination unit 113, and the prediction unit 114 included in the external environment recognition apparatus 50 will be described below.

In the self-drive mode, the driving control unit 115 generates a target path on the basis of the external environment situation around the vehicle that has been recognized by the external environment recognition apparatus 50, and controls the actuator AC so that the subject vehicle 101 travels along the target path. Note that in the manual drive mode, the driving control unit 115 controls the actuator AC in accordance with a traveling command (steering operation or the like) from the driver that has been acquired by the internal sensor group 3.

The LiDAR 5 will be further described.

### <Detection Area>

The LiDAR 5 is attached to face the front side of the subject vehicle 101 so that the FOV includes an area to be observed during traveling. Since the LiDAR 5 receives light scattered by a three-dimensional object or the like irradiated with irradiation light, the FOV of the LiDAR 5 corresponds to the irradiation range and the detection area of the irradiation light. That is, the irradiation point in the irradiation range corresponds to the detection point in the detection area.

In the embodiment, a road surface shape including an irregularity, a step, an undulation, or the like of a road surface, a three-dimensional object located on the road RD (equipment related to the road RD (a traffic light, a traffic sign, a groove, a wall, a fence, a guardrail, or the like)), an object on the road RD (including other vehicles or an obstacle on the road surface), or a division line provided on the road surface will be referred to as a three-dimensional object or the like. The division line includes a white line (including a line of a different color such as yellow), a curbstone line, a road stud, or the like, and may be referred to as a lane mark. In addition, a three-dimensional object or the like set in advance may be referred to as a detection target. In addition, a detection target on the road RD that may be an obstacle to the traveling subject vehicle 101 is referred to as a first three-dimensional object, and a detection target at a position higher than the road surface, such as a traffic light or a traffic sign, is referred to as a second three-dimensional object.

### <Example of Coordinate System>

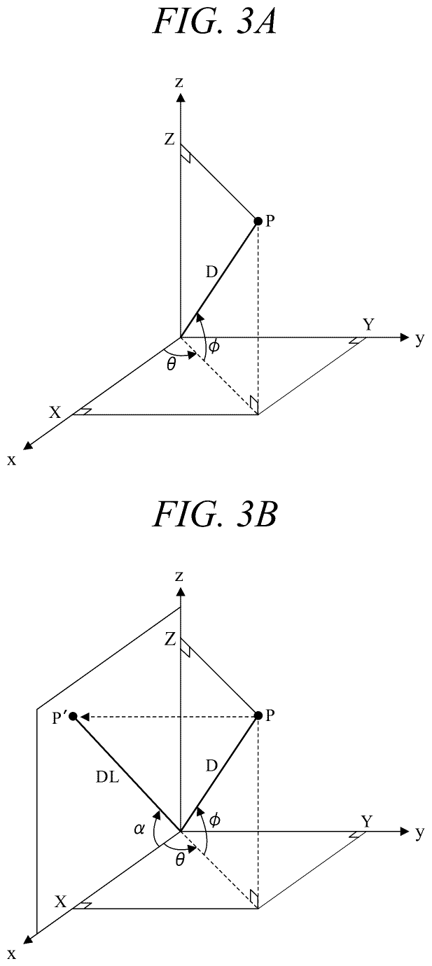

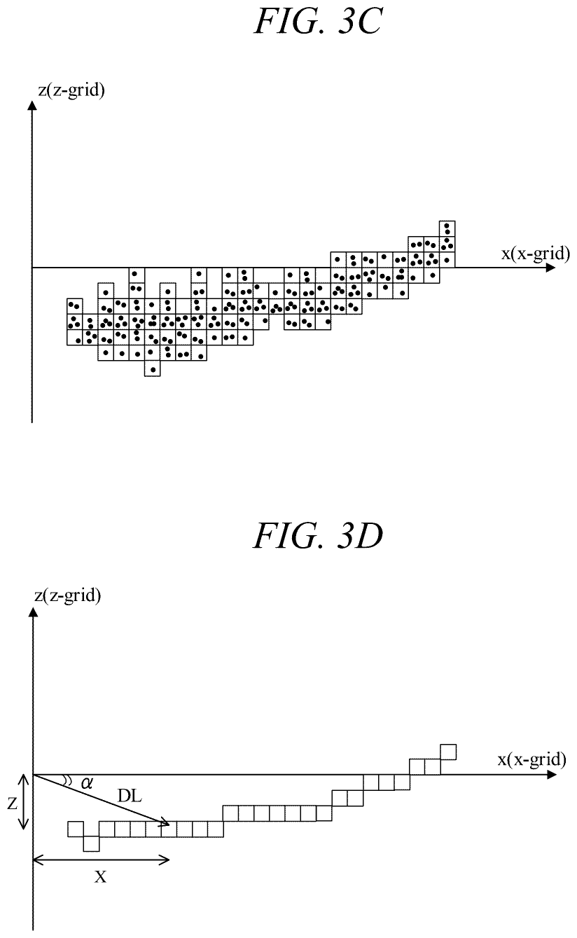

FIG. 3A is a diagram illustrating a position of point cloud data in a three-dimensional space using a three-dimensional coordinate system. In FIG. 3A, an x-axis plus direction corresponds to the advancing direction of the subject vehicle 101, a y-axis plus direction corresponds to a left side in a horizontal direction of the subject vehicle 101, and a z-axis plus direction corresponds to an upper side in a vertical direction.

In addition, an x-axis component of the position of data P will be referred to as a depth distance X, a y-axis component of the position of the data P will be referred to as a horizontal distance Y, and a z-axis component of the position of the data P will be referred to as a height Z.

Assuming that the distance measured by the LiDAR 5, in other words, the distance from the LiDAR 5 to a point on an object as a detection target is set to D, coordinates (X, Y, Z) indicating the position of the data P are calculated by the formulae described below.

$$X = D \times cos θ \times cos φ \qquad ( 1 )$$

$$Y = D \times sin θ \times cos φ \qquad ( 2 )$$

$$Z = D \times sin φ \qquad ( 3 )$$

Note that the angle θ will be referred to as a horizontal light projection angle, and the angle φ will be referred to as a vertical light projection angle. The horizontal light projection angle θ and the vertical light projection angle φ are set to the LiDAR 5 by the setting unit 112.

FIG. 3B is a diagram describing mapping of the point cloud data from the three-dimensional space to the two-dimensional X-Z space. In the embodiment, in order to calculate the road surface gradient of the road RD, mapping is performed from the data P in the three-dimensional space to data P′ in the X-Z space for each data constituting the point cloud data. By this mapping, three-dimensional point cloud data is converted into two-dimensional point cloud data in the X-Z space. In the X-Z space, information indicating the horizontal distance Y is omitted, and information of the depth distance X and the height Z remains.

Next, the X-Z space is divided by grids having a predetermined size (for example, 50 cm square), and the number of pieces of data P′ included in each grid is counted. FIG. 3C is a schematic diagram illustrating the point cloud data divided for each grid. Note that the number of grids based on the actual data P′ is much larger than the illustrated number.

FIG. 3C illustrates the position data (depth distance X) for each grid, the height Z for each grid, and the number of pieces of data P′ included in each grid. In the embodiment, since the data of the three-dimensional object is separated and excluded in advance, the data is mainly grid data of X and Z with respect to the data of the road surface. Therefore, by sequentially extracting the grid in which the number of pieces of data P′ in the grid is maximized in the depth distance X direction, a row of grids indicating the height Z of the road surface as illustrated in FIG. 3D, that is, the road surface gradient in the depth distance X direction can be obtained.

When attention is paid to each grid, Formula (4) described below is established between light projection angle α in the vertical direction with respect to the road surface point (corresponding to the irradiation point described above) of the grid, the depth distance X of the road surface point, and the height Z of the road surface. In addition, Formula (5) described below is established between a distance DL from the LiDAR 5 to the road surface point, the depth distance X of the road surface point, and the height Z of the road surface.

$$tan α = Z / X \qquad ( 4 )$$

$$DL = ( X 2 + Z 2 ) 1 / 2 \qquad ( 5 )$$

### <Light Projection Angle and Depth Distance>

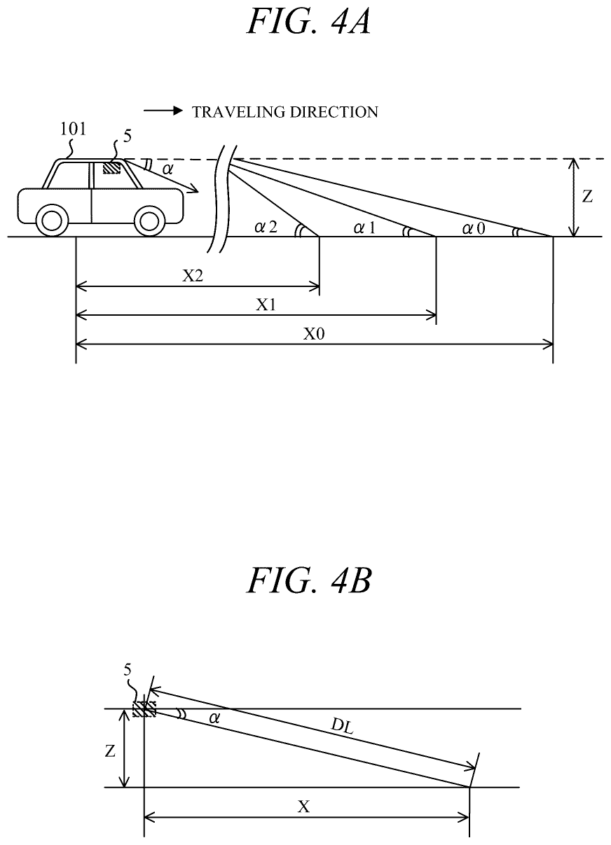

FIG. 4A is a schematic diagram illustrating a light projection angle α in the vertical direction of the LiDAR 5 (an angle of irradiation light with respect to the horizontal direction) and the depth distance X. By changing the light projection angle α, the external environment recognition apparatus 50 changes the irradiation direction of the irradiation light upward and downward so as to move the position of the irradiation point in the vertical direction.

In FIG. 4A, in a case where the irradiation light is emitted on the road RD at a location point where a depth distance X2 is 10 m, the road surface is irradiated at a light projection angle α2. In addition, in a case where the irradiation light is emitted on the road RD at a location point where a depth distance X1 is 40 m, the road surface is irradiated at a light projection angle α1. Further, in a case where the irradiation light is emitted on the road RD at a location point where a depth distance X0 is 100 m, the road surface is irradiated at a light projection angle α0.

In general, as the light projection angle α with respect to the road surface is smaller, the scattered light returning from the road surface to the LiDAR 5 becomes smaller. Therefore, in many cases, the reception level of the scattered light with respect to the irradiation light on the location point of the depth distance X0 is the lowest.

FIG. 4B is a schematic diagram illustrating the distance DL measured by the LiDAR 5. As described above with reference to FIGS. 3A to 3D, the external environment recognition apparatus 50 calculates the depth distance X to the road surface point that has been irradiated with the irradiation light and the height Z of the road surface point, by using the light projection angle α set to the LiDAR 5, the distance DL (optical path length of the irradiation light) measured by the LiDAR 5, and Formulae (4) and (5) described above.

The external environment recognition apparatus 50 sets the light projection angle α to the upper side in a case where the depth distance is desired to be longer than a current value and sets the light projection angle α to the lower side in a case where the depth distance is desired to be shorter than the current value. For example, in a case of changing the depth distance to 100 m from a state in which the irradiation light is emitted on the location point where the depth distance is 70 m, the external environment recognition apparatus 50 sets the light projection angle α to the upper side than the current light projection angle so that the irradiation light is emitted on the location point where the depth distance is 100 m. In addition, for example, in a case where the road RD is a downward gradient or the like and the road RD is not irradiated with the irradiation light, the external environment recognition apparatus 50 sets the light projection angle α to the lower side than the current light projection angle so that the road RD is irradiated with the irradiation light.

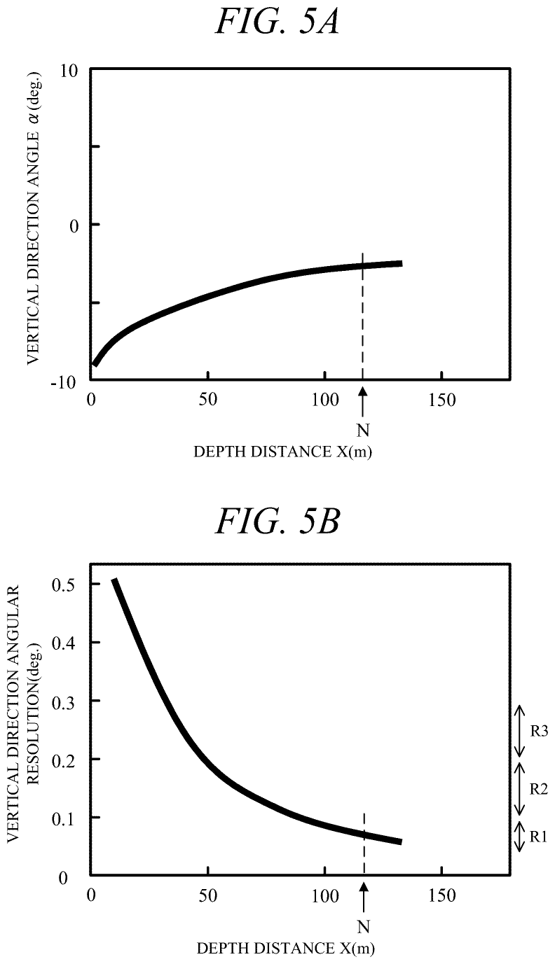

FIG. 5A is a schematic diagram illustrating an example of a relationship between the depth distance X and the light projection angle α in the vertical direction. The horizontal axis represents the depth distance X (unit: m), and the vertical axis represents the light projection angle α (unit: deg) in the vertical direction. The light projection angle a can be referred to as a vertical direction angle. As illustrated in FIG. 5A, the external environment recognition apparatus 50 increases the light projection angle α to a minus side in the case where the depth distance X is desired to be shorter, and increases the light projection angle α to a plus side in the case where the depth distance X is desired to be longer. Reference sign N will be described below.

### <FOV and Depth Distance>

In the embodiment, at least the road surface situation from the depth distance X2 to the depth distance X0 in FIG. 4A and the detection target provided at a predetermined height on the road RD are detected from the FOV of the LiDAR 5.

In general, the camera 4 is superior to the LiDAR 5 in terms of resolution at short distances, and the LiDAR 5 is superior to the camera 4 in terms of distance measurement accuracy and relative speed measurement accuracy. Therefore, in a case where the angle of view of the camera 4 is wider in the vertical direction than the FOV of the LiDAR 5, the external environment recognition apparatus 50 may cause the camera 4 to detect the road surface situation for a lower side of the lower end of the FOV of the LiDAR 5 (in other words, a road surface close to the subject vehicle 101).

### <Number of Irradiation Points of Irradiation Light>

The external environment recognition apparatus 50 calculates the position of an irradiation point to be irradiated with the irradiation light of the LiDAR 5 in the FOV of the LiDAR 5. More specifically, the external environment recognition apparatus 50 calculates an irradiation point in accordance with an angular resolution to be calculated based on a minimum size (for example, 15 cm in both vertical direction and horizontal direction) of the first three-dimensional object that has been designated in advance as a detection target and the required depth distance (for example, 100 m). The required depth distance corresponds to a braking distance of the subject vehicle 101 that changes depending on the vehicle speed. The first three-dimensional object is, for example, a stone or a concrete piece on a road.

In the embodiment, a value obtained by giving a predetermined margin to the braking distance will be referred to as the required depth distance based on the idea that the road surface situation of the road in the advancing direction of the traveling subject vehicle 101 should be detected for at least beyond the braking distance. The vehicle speed of the subject vehicle 101 is detected by the vehicle speed sensor of the internal sensor group 3. The relationship between the vehicle speed and the required depth distance is stored in advance in the memory unit 12. Reference sign N in FIG. 5A indicates the required depth distance when the vehicle speed is, for example, 100 km/h.

As an example of the angular resolution in a case where a detection target of 15 cm is detected at 100 m as the required depth distance, 0.05 deg is required in each of the vertical direction and the horizontal direction as described below with reference to FIG. 5B. Note that in a case where a detection target having a smaller size than 15 cm is detected, and in a case where a detection target of 15 cm is detected at the depth distance X longer than 100 m, it is necessary to further increase the number of irradiation points in the FOV by increasing the angular resolution.

In addition, the external environment recognition apparatus 50 is also configured to be able to calculate the irradiation point according to the angular resolution calculated on the basis of the size of the second three-dimensional object designated in advance as the detection target. The second three-dimensional object is a detection target installed at a predetermined height from the road surface at a position away from the subject vehicle 101 by a predetermined depth distance.

The predetermined depth distance is, for example, from the depth distance corresponding to the lower end of the FOV of the LiDAR 5 to a depth distance of 120 m. The second three-dimensional object corresponds to, for example, the traffic light SG installed at a height of up to 6 m from the road surface. The 6 m is a value obtained by giving a predetermined margin to the height of the installation reference of the traffic light.

For example, the external environment recognition apparatus 50 calculates the positions of the irradiation points so as to be arranged in a lattice pattern in the FOV, and causes the intervals of the lattice points in the vertical direction and the horizontal direction to respectively correspond to the angular resolutions in the vertical direction and the horizontal direction. In a case of increasing the angular resolution in the vertical direction, the FOV is divided in the vertical direction by the number based on the angular resolution, and the lattice interval in the vertical direction is narrowed to increase the number of irradiation points. In other words, the interval of the irradiation points is made dense. On the other hand, in a case of reducing the angular resolution in the vertical direction, the FOV is divided in the vertical direction by the number based on the angular resolution, and the lattice interval in the vertical direction is widened to reduce the number of irradiation points. In other words, the interval of the irradiation points is made sparse. The same applies to the horizontal direction.

The external environment recognition apparatus 50 generates information (hereinafter, referred to as irradiation point information) indicating the position of the irradiation point that has been calculated in accordance with the angular resolution, and stores, in the memory unit 12, the information in association with the position information indicating the current traveling position of the subject vehicle 101.

### <Angular Resolution and Depth Distance>

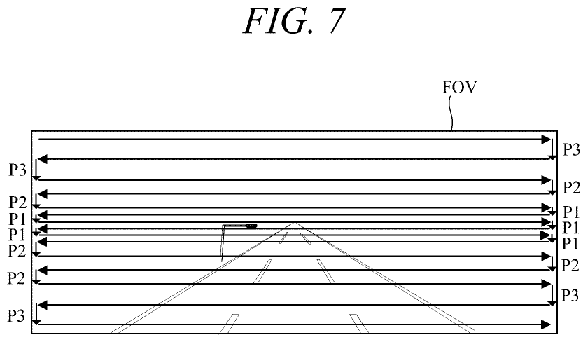

FIG. 5B is a schematic diagram illustrating an example of the relationship between the depth distance X and the angular resolution in the vertical direction, and illustrates the angular resolution (also referred to as required angular resolution) required for recognizing the detection target having the above-described size (15 cm both vertically and horizontally). The horizontal axis represents the depth distance X (unit: m), and the vertical axis represents the angular resolution (unit: deg) in the vertical direction. In general, as the depth distance X decreases (in other words, the detection target is closer to the subject vehicle 101), the viewing angle with respect to the detection target increases. Therefore, it is possible to detect the detection target even when the angular resolution is low. On the other hand, as the depth distance X increases (in other words, the detection target is far from the subject vehicle 101), the viewing angle with respect to the detection target decreases. Therefore, a high angular resolution is required for detecting the detection target. For this reason, as illustrated in FIG. 5B, the external environment recognition apparatus 50 decreases the angular resolution (increases the numerical value of the angular resolution) as the depth distance Xis shorter, and increases the angular resolution (decreases the numerical value of the angular resolution) as the depth distance X is longer. R1, R2 and R3 correspond to P1, P2 and P3 in FIG. 7 to be described below, respectively.

Note that although not illustrated, the same applies to the relationship between the depth distance X and the angular resolution in the horizontal direction.

Reference sign N in FIG. 5B indicates the required depth distance when the vehicle speed is, for example, 100 km/h.

While the subject vehicle 101 is traveling in the self-drive mode, the external environment recognition apparatus 50 sets a predetermined irradiation point (a detection point) in the FOV, and also controls the LiDAR 5 to emit the irradiation light. Thus, the irradiation light from the LiDAR 5 is emitted toward the irradiation point (the detection point) that has been set.

Note that the irradiation light of the LiDAR 5 may be emitted in a raster scanning method on all irradiation points (detection points) arranged in a lattice pattern in the FOV, or the irradiation light may be intermittently emitted so that the irradiation light is emitted only on a predetermined irradiation point (a detection point), or may be emitted in any other mode.

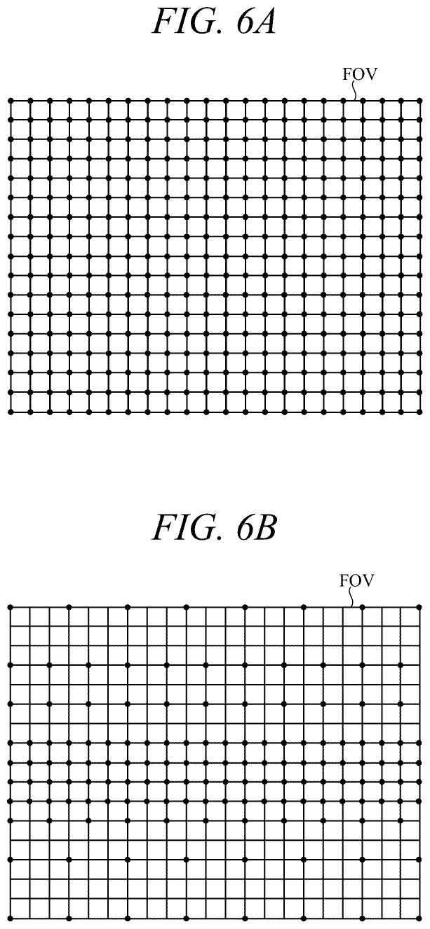

FIG. 6A is a schematic diagram illustrating an example of irradiation points in a case where the irradiation light of the LiDAR 5 is emitted in the raster scanning method. When emitting the irradiation light from the LiDAR 5, the external environment recognition apparatus 50 sets the angular resolution required at a required depth distance N for the entire area in the FOV, and controls the irradiation direction of the irradiation light.

For example, in a case where the required angular resolution for recognizing the detection target present at a location point of the required depth distance N on the road RD is 0.05 deg both vertically (in the vertical direction) and horizontally (in the horizontal direction), the external environment recognition apparatus 50 controls the irradiation direction of the irradiation light to be shifted at an interval of 0.05 deg vertically and horizontally in the entire area of the FOV. That is, in FIG. 6A, each black circle of the lattice point corresponds to the irradiation point (the detection point), and the vertical and horizontal intervals of the irradiation points (the detection points) correspond to an angular resolution of 0.05 deg.

The number of actual irradiation points in the FOV is much larger than the number of black circles illustrated in FIG. 6A. As a specific example, in a case where the FOV of the LiDAR 5 is 120 deg in the horizontal direction, 2400 black circles corresponding to the irradiation points (the detection points) are arranged at an interval of 0.05 deg in the horizontal direction. Similarly, in a case where the FOV is 40 deg in the vertical direction, 800 black circles corresponding to the irradiation points (the detection points) are arranged at an interval of 0.05 deg in the vertical direction.

The external environment recognition apparatus 50 acquires detection data of the detection points corresponding to the irradiation points in FIG. 6A each time the irradiation light for one frame is scanned with respect to the FOV, and extracts data of the detection points based on the angular resolution required for the recognition of the detection target from these pieces of detection data. More specifically, for an area in the FOV in which the depth distance X is shorter than the required depth distance N and the required angular resolution of 0.1 deg is sufficient instead of 0.05 deg, data is extracted so that the vertical and horizontal data intervals are wider than the interval of 0.05 deg. In addition, also for an area in the FOV corresponding to the sky, the road RD is not present, and thus data is extracted so as to widen the vertical and horizontal data intervals. The interval of the detection points that have been extracted in this manner is similar to the interval of the detection points indicated by black circles in FIG. 6B to be described below.

The external environment recognition apparatus 50 extracts the data of the detection points, thereby enabling the total number of pieces of detection data for use in the recognition processing to be suppressed.

FIG. 6B is a schematic diagram illustrating an example of irradiation points in a case where the irradiation light of the LiDAR 5 is emitted only on predetermined irradiation points (detection points) arranged in a lattice pattern in the FOV. When emitting the irradiation light from the LiDAR 5, the external environment recognition apparatus 50 sets the interval of irradiation points (detection points) in the FOV to an interval corresponding to the required angular resolution, and controls the irradiation direction of the irradiation light.

For example, in a case where the required angular resolution for recognizing the detection target present at a location point of the required depth distance N on the road RD is 0.05 deg both vertically (in the vertical direction) and horizontally (in the horizontal direction), the external environment recognition apparatus 50 controls the irradiation direction of the irradiation light to be shifted at an interval of 0.05 deg vertically and horizontally in the area corresponding to the required depth distance N (a band-shaped area that is long in the left-right direction).

In addition, for an area in the FOV in which the depth distance X is shorter than the required depth distance N and the required angular resolution of 0.1 deg is sufficient, the irradiation direction of the irradiation light is controlled to widen the vertical and horizontal intervals of the detection points. Further, also for an area in the FOV corresponding to the sky, the road RD is not present, and thus the irradiation direction of the irradiation light is controlled to widen the vertical and horizontal intervals of the detection points. As an example, at the beginning of the irradiation, the irradiation is started in a sparse-density distribution of the irradiation points (the detection points) in a state where the road surface is flat or in a state where the measurement was performed last time.

The external environment recognition apparatus 50 controls the interval (sparse-density state) of the irradiation points at the time of scanning irradiation, thereby enabling the total number of pieces of detection data for use in the recognition processing to be suppressed.

Note that the number of actual irradiation points in the FOV is much larger than the number of black circles illustrated in FIG. 6B.

FIG. 7 is a diagram illustrating an example of an irradiation order in a case where the irradiation points illustrated in FIG. 6B are irradiated with the irradiation light. In FIG. 7, the irradiation directions of the irradiation light are controlled in directions of arrows from upper left irradiation points to lower right irradiation points of the FOV. In addition, characters P1 to P3 written together with vertical arrows indicate the magnitude of the interval between the irradiation points (the detection points). P1 indicates, for example, an interval of the irradiation points (the detection points) corresponding to an angular resolution of 0.05 deg. P2 indicates, for example, an interval of the irradiation points (the detection points) corresponding to an angular resolution of 0.1 deg. P3 indicates, for example, an interval of the irradiation points (the detection points) corresponding to an angular resolution of 0.2 deg.

FIG. 7 illustrates an example in which the angular resolution is switched in three stages. However, without being limited to the three stages, and the angular resolution may be configured to be appropriately switched in two or more stages. For example, in addition to the intervals P1, P2, and P3 of the irradiation points (the detection points), the interval may be switched to an interval P4 of the irradiation points (the detection points) corresponding to an angular resolution of 0.3 deg.

### <Configuration of External Environment Recognition Apparatus>

Details of the external environment recognition apparatus 50 will be described.

As described above, the external environment recognition apparatus 50 includes the recognition unit 111, the setting unit 112, the determination unit 113, the prediction unit 114, and the LiDAR 5.

### <Recognition Unit>

The recognition unit 111 generates three-dimensional point cloud data using time-series detection data detected in the FOV of the LiDAR 5.

In addition, the recognition unit 111 recognizes a road structure in the advancing direction of the road RD on which the subject vehicle 101 travels, and a detection target on the road RD in the advancing direction based on the detection data measured by the LiDAR 5. The road structure refers to, for example, a straight road, a curved road, a branch road, a tunnel entrance, or the like.

Further, for example, by performing luminance filtering processing or the like on data indicating a flat road surface, the recognition unit 111 senses a division line. In this case, in a case where the height of the road surface on which the luminance exceeds a predetermined threshold is substantially the same as the height of the road surface on which the luminance does not exceed the predetermined threshold, the recognition unit 111 may determine that it is a division line.

### <Recognition of Road Structure>

An example of recognition of the road structure by the recognition unit 111 will be described. The recognition unit 111 recognizes, as boundary lines RL and RB of the road RD (FIG. 1A), a curbstone, a wall, a groove, a guardrail, or a division line on the road RD on a forward side, which is the advancing direction, included in the generated point cloud data, and recognizes a road structure in the advancing direction indicated by the boundary lines RL and RB. As described above, the division line includes a white line (including a line in a different color), a curbstone line, a road stud, or the like, and a traveling lane of the road RD is defined by markings with these division lines. In the embodiment, the boundary lines RL and RB on the road RD defined by the above markings will be referred to as division lines.

The recognition unit 111 recognizes an area interposed between the boundary lines RL and RB as an area corresponding to the road RD. Note that the method for recognizing the road RD is not limited thereto, and the road RD may be recognized by another method.

In addition, the recognition unit 111 separates the generated point cloud data into point cloud data indicating a flat road surface and point cloud data indicating a three-dimensional object or the like. For example, among three-dimensional objects or the like on the road in the advancing direction included in the point cloud data, road surface shapes such as irregularities, steps, and undulations that exceed 15 cm in size and objects that exceed 15 cm both vertically and horizontally are recognized as detection targets. The 15 cm is an example of a size of a detection target as the first three-dimensional object, and the size of the detection target may be appropriately changed.

The recognition unit 111 further recognizes the traffic light SG as the second three-dimensional object as a detection target.

### <Setting Unit>

The setting unit 112 sets the vertical light projection angle q of the irradiation light to the LiDAR 5. In a case where the FOV of the LiDAR 5 is 40 deg in the vertical direction, the vertical light projection angle q is set in a range of 0 to 40 deg at an interval of 0.05 deg. Similarly, the setting unit 112 sets the horizontal light projection angle θ of the irradiation light to the LiDAR 5. In a case where the FOV of the LiDAR 5 is 120 deg in the horizontal direction, the horizontal light projection angle θ is set in a range of 0 to 120 deg at an interval of 0.05 deg.

The setting unit 112 sets the number of irradiation points (corresponding to the number of black circles in FIGS. 6A and 6B and indicating the irradiation point density) in the FOV to the LiDAR 5 based on the angular resolution determined by the determination unit 113 as will be described below. As described above, the intervals in the vertical direction and the horizontal direction of the irradiation points (the detection points) arranged in a lattice pattern in the FOV are respectively caused to correspond to the angular resolutions in the vertical direction and the horizontal direction.

### <Determination Unit>

The determination unit 113 determines the angular resolution (scanning angular resolution) at the time of scanning using the required angular resolution based on the size of the first three-dimensional object and the required angular resolution based on the size of the second three-dimensional object.

### (Angular Resolution Based on Size of First Three-Dimensional Object)

First, the determination unit 113 calculates the light projection angle α in the vertical direction at each depth distance X and the distance DL to the road surface point at each depth distance X. Specifically, as described with reference to FIG. 3D, the depth distance X is calculated based on the distance DL to the road surface point measured by the LiDAR 5 and the light projection angle α set in the LiDAR 5 at the time of measurement. The determination unit 113 calculates a relationship between the calculated depth distance X and the vertical direction angle (FIG. 5A). In addition, the determination unit 113 calculates a relationship between the depth distance X and the distance DL. Furthermore, as illustrated in FIG. 5B, the determination unit 113 calculates a relationship between the depth distance X and the vertical angular resolution based on the size of the first three-dimensional object as the detection target and the depth distance X. In this manner, the vertical angular resolution is calculated based on the size of the first three-dimensional object and the distance DL, and the relationship between the depth distance X and the vertical angular resolution is calculated based on the distance DL and the depth distance X.

Next, the determination unit 113 temporarily determines the angular resolution in the vertical direction required for recognizing the first three-dimensional object having the above-described size. For example, for the depth distance X at which the angular resolution in the vertical direction is smaller than 0.1 deg in FIG. 5B, 0.05 deg, which is smaller than 0.1 deg, is determined as the required angular resolution. In addition, for the depth distance X at which the angular resolution in the vertical direction is equal to or larger than 0.1 deg and smaller than 0.2 deg, 0.1 deg, which is smaller than 0.2 deg, is determined as the required angular resolution. Similarly, for the depth distance X at which the angular resolution in the vertical direction is equal to or larger than 0.2 deg and smaller than 0.3 deg and the depth distance X at which the angular resolution in the vertical direction is equal to or larger than 0.3 deg and smaller than 0.4 deg, 0.2 deg and 0.3 deg, which are smaller than 0.3 deg and 0.4 deg, respectively, are temporarily determined as the required angular resolutions based on the first three-dimensional object.

### (Angular Resolution Based on Second Three-Dimensional Object)

Subsequently, the determination unit 113 calculates the light projection angle α in the vertical direction in a range where the second three-dimensional object as the detection target can exist and the distance DL to the second three-dimensional object corresponding to each depth distance X.

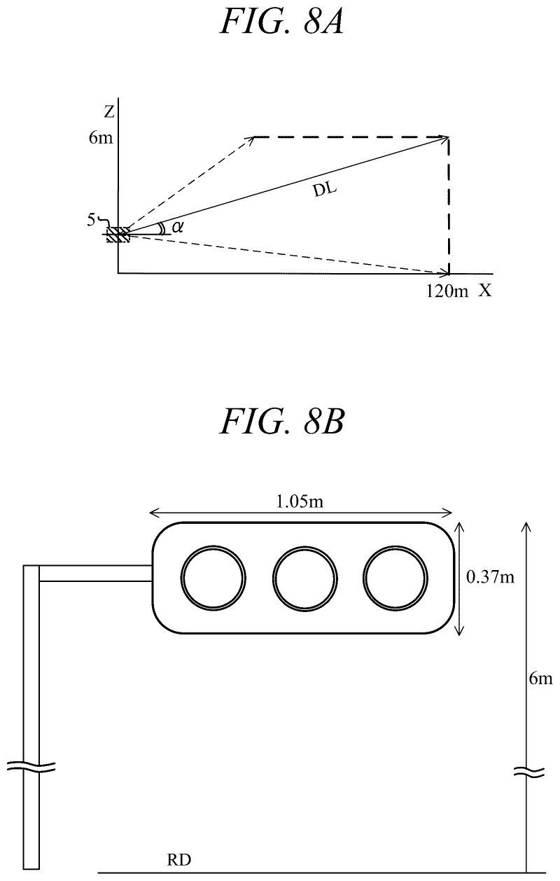

FIG. 8A is a schematic diagram illustrating a range (hereinafter, referred to as an existence range) in which the traffic light SG as the second three-dimensional object can exist at a predetermined height from the road surface. The horizontal axis represents the depth distance X (unit: m), and the vertical axis represents the height Z (unit: m) in the vertical direction. In the embodiment, a range indicated by a boundary line (thick broken line) from a depth distance corresponding to the lower end of the FOV of the LiDAR 5 to a depth distance of 120 m at a height of up to 6 m from the road surface is treated as the existence range.

Note that when the road RD on which the subject vehicle 101 travels is an uphill, and the road surface gradient is not parallel to the horizontal axis but right upward in FIG. 8A, the range from the road surface indicated by the road surface gradient to the height of 6 m is treated as the existence range of the traffic light SG at each depth distance. FIG. 8B is a diagram illustrating an example of the size of traffic light SG.

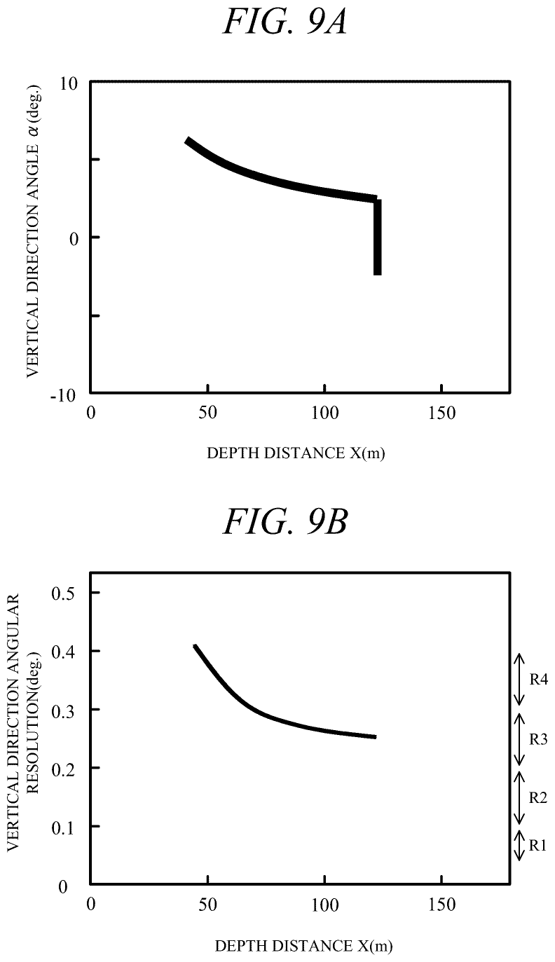

FIG. 9A is a schematic diagram illustrating an example of a relationship between the depth distance X and the light projection angle α in the vertical direction with respect to the grid point (corresponding to the irradiation point described above) corresponding to the position on the boundary line in FIG. 8A. The horizontal axis represents the depth distance X (unit: m), and the vertical axis represents the light projection angle α (unit: deg) in the vertical direction. As described above, the light projection angle α corresponds to the vertical direction angle. As illustrated in FIG. 9A, the external environment recognition apparatus 50 increases the light projection angle α to a plus in a case where the depth distance X is short and decreases the light projection angle α in a case where the depth distance X is long.

The determination unit 113 calculates the light projection angle α in the vertical direction with respect to the aforementioned grid point at each depth distance X and the distance DL from the LiDAR 5 to the aforementioned grid point at each depth distance X. Specifically, the depth distance X is calculated based on the distance DL and the light projection angle α with respect to the aforementioned grid point by the same method as in the case of FIG. 5A. The determination unit 113 calculates a relationship between the calculated depth distance X and the vertical direction angle (FIG. 9A). In addition, the determination unit 113 calculates a relationship between the depth distance X and the distance DL to the aforementioned grid point. Furthermore, the determination unit 113 calculates a relationship between the depth distance X and the vertical angular resolution based on the size of the traffic light SG as the detection target and the depth distance X. FIG. 9B is a schematic diagram illustrating an example of the relationship between the depth distance X and the angular resolution in the vertical direction, and illustrates the angular resolution (also referred to as required angular resolution) required for recognizing the traffic light SG having a length of 0.37 m. The horizontal axis represents the depth distance X (unit: m), and the vertical axis represents the angular resolution (unit: deg) in the vertical direction. R1, R2, R3 and R4 correspond to the aforementioned P1, P2, P3 and P4, respectively.

In this manner, the vertical angular resolution is calculated based on the size of the second three-dimensional object (traffic light SG) and the distance DL, and the relationship between the depth distance X and the vertical angular resolution is calculated based on the distance DL and the depth distance X.

Next, the determination unit 113 temporarily determines the angular resolution in the vertical direction required for recognizing the second three-dimensional object having the above-described size. For example, for the depth distance X at which the angular resolution in the vertical direction is equal to or larger than 0.2 deg and smaller than 0.3 deg in FIG. 9B, 0.2 deg, which is smaller than 0.3 deg, is determined as the required angular resolution. In addition, for the depth distance X at which the angular resolution in the vertical direction is equal to or larger than 0.3 deg and smaller than 0.4 deg and the depth distance X at which the angular resolution in the vertical direction is equal to or larger than 0.4 deg and smaller than 0.5 deg, 0.3 deg and 0.4 deg, which are smaller than 0.4 deg and 0.5 deg, respectively, are temporarily determined as the required angular resolutions based on the second three-dimensional object.

The determination unit 113 determines the angular resolution at the time of scanning in the vertical direction based on the required angular resolution based on the first three-dimensional object temporarily determined as described above and the required angular resolution based on the second three-dimensional object temporarily determined as described above.

The determined angular resolution in the vertical direction can be reflected as an interval in the vertical direction between detection points when three-dimensional point cloud data for the next frame is acquired.

In addition, the determination unit 113 may determine the angular resolution in the horizontal direction for recognizing the detection target in accordance with the size of the detection target and the depth distance X. The angular resolution in the horizontal direction can also be reflected as an interval in the horizontal direction between detection points when three-dimensional point cloud data for the next frame is acquired.

Note that the angular resolution in the horizontal direction may be matched with the angular resolution in the vertical direction that has been determined previously. In other words, on the same horizontal line with the detection point at which the required angular resolution in the vertical direction has been determined to be 0.05 deg, the required angular resolution in the horizontal direction is determined to be 0.05 deg. Similarly, on the same horizontal line with the detection point at which the required angular resolution in the vertical direction has been determined to be 0.1 deg, the required angular resolution in the horizontal direction is determined to be 0.1 deg. Further, for other required angular resolutions, on the same horizontal line with the detection point at which the required angular resolution in the vertical direction has been determined, the required angular resolution in the horizontal direction is determined to be the same value as the required angular resolution in the vertical direction.

### <Prediction Unit>

In a case where the advancing direction of the road RD on which the subject vehicle 101 travels is a downhill and the reflection angle from the road surface becomes small, or in a situation where the vehicle speed is fast and the required depth distance N increases, the LiDAR 5 may not be able to receive the scattered light up to the required depth distance N. In this case, the farthest depth distance X that can be detected by the LiDAR 5 is referred to as a maximum depth distance L. The maximum depth distance may be referred to as a maximum road surface detection distance.

When the required depth distance N calculated from the vehicle speed of the subject vehicle 101 exceeds the maximum depth distance L (for example, when the required depth distance N=108 m, the maximum depth distance L=92 m), the prediction unit 114 predicts the height Z (gradient) of the road surface from the maximum depth distance L to the required depth distance N using the measurement data practically acquired by the LiDAR 5 from the depth distance corresponding to the lower end of the FOV to the maximum depth distance L. For the prediction of the gradient, for example, an AR model or an ARIMA model that is a time series prediction method can be used.

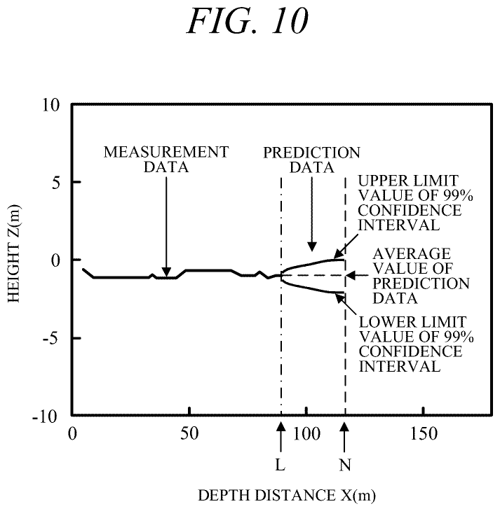

FIG. 10 illustrates an example of a result of prediction using an ARIMA model. The horizontal axis represents the depth distance X (unit: m), and the vertical axis represents the height Z (unit: m) of the road surface. As the prediction result, an average value of the predicted height Z, upper and lower limit values (for example, a reliability of 99% is set) of the predicted height Z, and the like are obtained. In the embodiment, a prediction value corresponding to the curve of the upper limit value of a reliability of 99% in the direction in which the area of angular resolution in the vertical direction is further expanded is adopted as the “upper limit value of the predicted height”. With this configuration, in a case where the road RD in the FOV is an uphill, by setting the angular resolution in the vertical direction to be high in the area on the upper side in the vertical direction, it is possible to reduce the possibility of missing data when acquiring the three-dimensional point cloud data of the next frame. On the other hand, in a case where the road RD is a downhill, since the road surface is not irradiated with the irradiation light from the LiDAR 5 in the first place, the area may not be expanded to the lower side in the vertical direction. Therefore, in order to avoid unnecessary processing, the prediction value corresponding to the curve of the lower limit value of a reliability of 99% is not adopted.

As described above, the prediction unit 114 predicts the data of the road surface gradient from the maximum depth distance L to the required depth distance N using the “upper limit value of the predicted height” by an ARIMA model or the like.

Note that, in the embodiment, the measurement data practically acquired by the LiDAR 5 is used for the data of the road surface gradient on the subject vehicle 101 side with respect to the maximum depth distance L, but the average value of the height Z predicted using an ARIMA model or the like may be used instead of the measurement data by the LiDAR 5. When the average value of the height Z is used, the effect of the flattening processing can be obtained.

### <Generation of Position Data>

The external environment recognition apparatus 50 is capable of generating continuous position data by mapping data indicating positions of detection targets detected based on time-series point cloud data measured in real time by the LiDAR 5, for example, on an X-Y two-dimensional map. In an X-Y space, information indicating the height Z is omitted, and information of the depth distance X and the horizontal distance Y remains.

The recognition unit 111 acquires the position information of a three-dimensional object or the like on the two-dimensional map stored in the memory unit 12, and calculates a relative position of the three-dimensional object or the like through coordinate conversion with the position of the subject vehicle 101 as the center, from the moving speed and the moving direction (for example, an azimuth angle) of the subject vehicle 101. Whenever the point cloud data is acquired by the LiDAR 5 by measurement, the recognition unit 111 converts the coordinates of the relative position of the three-dimensional object or the like based on the acquired point cloud data with the position of the subject vehicle 101 as the center, and records the converted position on the two-dimensional map.

### <Description of Flowchart>

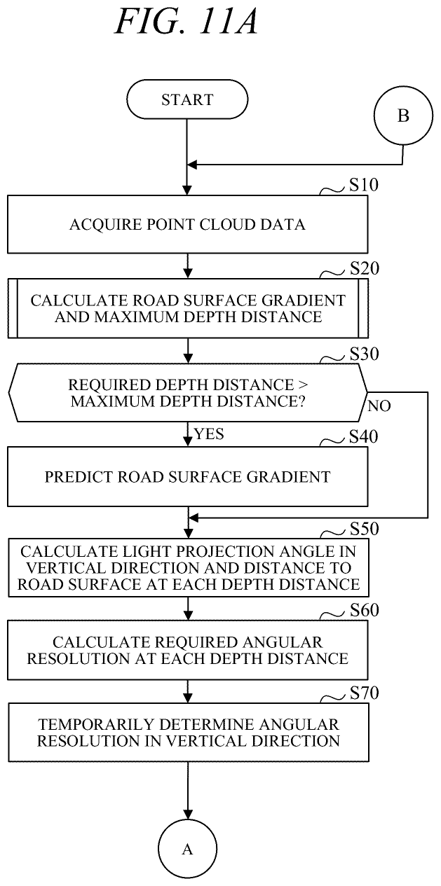

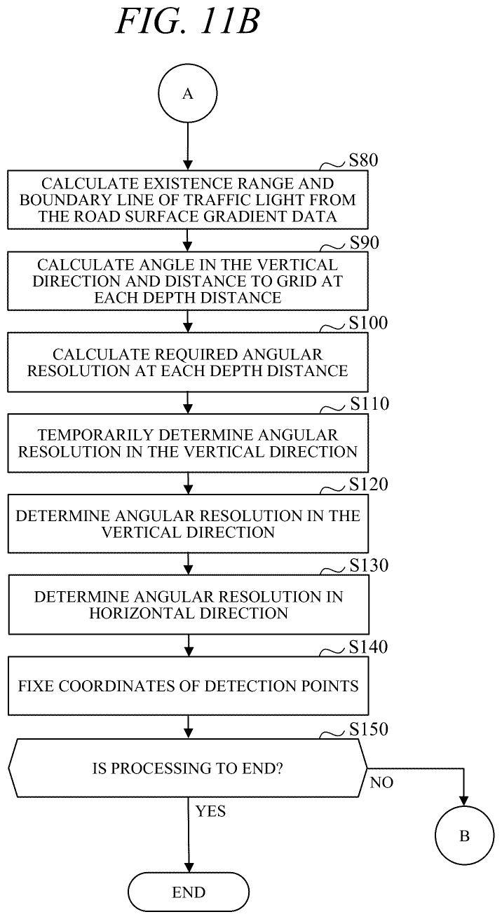

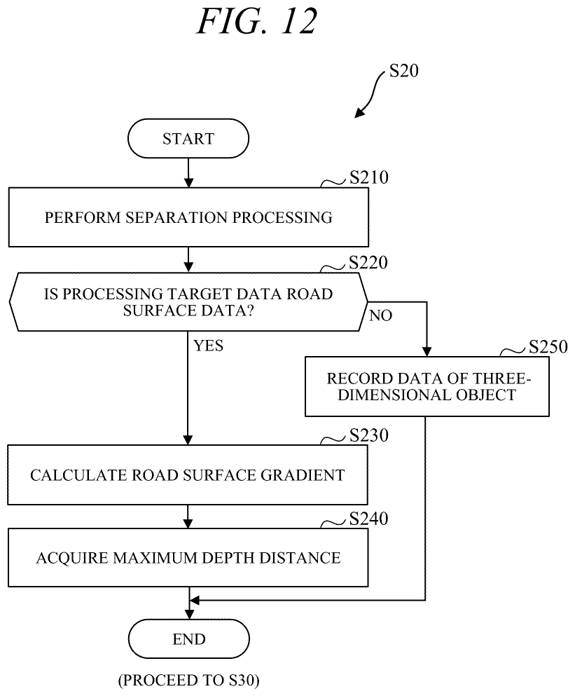

FIGS. 11A, 11B, and 12 are flowcharts illustrating an example of processing executed by the processing unit 11 of the controller 10 in FIG. 2 in accordance with a predetermined program. The processing illustrated in the flowcharts of FIGS. 11A, 11B, and 12 is repeated, for example, every predetermined cycle while the subject vehicle 101 is traveling in the self-drive mode.

First, in step S10 in FIG. 11A, the processing unit 11 causes the LiDAR 5 to acquire three-dimensional point cloud data, and proceeds to step S20.

In step S20, the processing unit 11 calculates the road surface gradient in the advancing direction of the road RD and the maximum depth distance L on the basis of the point cloud data acquired by the LiDAR 5, and proceeds to step S30. Details of the processing in step S20 will be described below with reference to FIG. 12.

In step S30, the prediction unit 114 of the processing unit 11 determines whether or not the maximum depth distance Lis shorter than the required depth distance N. When the maximum depth distance L is shorter than the required depth distance N, the processing unit 11 makes an affirmative determination in step S30 and proceeds to step S40, and when the maximum depth distance L is longer than the required depth distance N, the processing unit 11 makes a negative determination in step S30 and proceeds to step S50.

In step S40, the prediction unit 114 of the processing unit 11 predicts the road surface gradient from the maximum depth distance L to the required depth distance N, and proceeds to step S50. An example of the prediction result of the road surface gradient is as illustrated in FIG. 10.

In step S50, the processing unit 11 calculates a light projection angle α in the vertical direction and a distance DL to the road surface at each depth distance X, and proceeds to step S60. The relationship between the vertical direction angle and the depth distance X is as illustrated in FIG. 5A. In addition, the relationship between the depth distance X, the height Z of the road surface, and the distance DL to the road surface is as illustrated in FIG. 4B.

In step S60, the processing unit 11 calculates the required angular resolution at each depth distance X, and proceeds to step S70. The required angular resolution is an angular resolution required for detecting a detection target having the size of the first three-dimensional object designated in advance. The relationship between the depth distance X and the angular resolution is as illustrated in FIG. 5B.

In step S70, the processing unit 11 temporarily determines, by the determination unit 113, the required angular resolution in the vertical direction based on the first three-dimensional object as the angular resolution at the time of scanning (first angular resolution), and proceeds to step S80 in FIG. 11B.

In step S80 of FIG. 11B, the processing unit 11 calculates the existence range of the traffic light SG as the second three-dimensional object and the boundary line (FIG. 8A) from the road surface gradient data, and proceeds to step S90.

In step S90, the processing unit 11 calculates a light projection angle α in the vertical direction and a distance DL to the grid at each depth distance X, and proceeds to step S100. The relationship between the vertical direction angle and the depth distance X is as illustrated in FIG. 9A. In addition, the relationship between the depth distance X, the height Z of the boundary line, and the distance DL to the grid corresponding to the position on the boundary line is as illustrated in FIG. 8A.

In step S100, the processing unit 11 calculates a required angular resolution at each depth distance X, and proceeds to step S110. The required angular resolution is an angular resolution required for detecting a detection target having the size of the second three-dimensional object designated in advance. The relationship between the depth distance X and the angular resolution is as illustrated in FIG. 9B.

In step S110, the processing unit 11 temporarily determines, by the determination unit 113, the required angular resolution in the vertical direction based on the second three-dimensional object as the angular resolution at the time of scanning (second angular resolution), and proceeds to step S120.

In the embodiment, the angular resolution in the vertical direction is determined prior to the angular resolution in the horizontal direction.

In step S120, the processing unit 11 determines, by the determination unit 113, the angular resolution at the time of scanning in the vertical direction based on the temporarily determined angular resolution based on the first three-dimensional object and the temporarily determined angular resolution based on the second three-dimensional object, and proceeds to step S130.

As an example, the determination unit 113 determines the higher one of the first angular resolution and the second angular resolution as the angular resolution at the time of scanning in the vertical direction of the next frame. The setting unit 112 controls the scanning irradiation of the electromagnetic waves by the LiDAR 5 at the angular resolution determined by the determination unit 113.

In addition, as another example, the determination unit 113 may determine the first angular resolution as the angular resolution at the time of scanning in the vertical direction of the next frame in a case where the second three-dimensional object is not recognized by the recognition unit 111, and may determine the higher one of the first angular resolution and the second angular resolution as the angular resolution at the time of scanning in the vertical direction of the next frame in a case where the second three-dimensional object is recognized by the recognition unit 111.

In step S130, the determination unit 113 of the processing unit 11 determines the angular resolution at the time of scanning in the horizontal direction, and proceeds to step S140. By determining the angular resolution in the horizontal direction after the angular resolution in the vertical direction, it becomes easy to make the angular resolution in the horizontal direction match the angular resolution in the vertical direction.

In step S140, the processing unit 11 fixes the coordinates of the detection points. More specifically, the coordinates indicating the position of the detection points as exemplified by the black circles in FIG. 6B are determined. The recognition unit 111 recognizes a three-dimensional object or the like in the advancing direction of the road RD on which the subject vehicle 101 travels based on the detection data detected at the position of the detection points fixed in step S140.

Note that whenever the point cloud data is acquired in step S10, the processing unit 11 maps the relative position of the three-dimensional object or the like based on the point cloud data on the X-Y two-dimensional map, and generates position data that is continuous in a two-dimensional manner. Then, the relative position of the three-dimensional object or the like based on the point cloud data can be converted into the coordinates with the position of the subject vehicle 101 as the center, and the coordinates can be recorded on the two-dimensional map.

In step S150, the processing unit 11 determines whether to end the processing. In a case where the subject vehicle 101 is continuously traveling in the self-drive mode, the processing unit 11 makes a negative determination in step S150, returns to step S10 in FIG. 11A, and repeats the above-described processing. By returning to step S10, the measurement of the three-dimensional object or the like based on the point cloud data is periodically and repeatedly performed while the subject vehicle 101 is traveling. On the other hand, in a case where the subject vehicle 101 has finished traveling in the self-drive mode, the processing unit 11 makes an affirmative determination in step S150, and ends the processing of FIG. 11B.

FIG. 12 is a flowchart for describing details of the processing of step S20 (FIG. 11A) executed by the processing unit 11. The processing unit 11 performs processing according to FIG. 12 on the point cloud data of the detection points determined by the determination unit 113.

In step S210, the processing unit 11 performs separation processing on the point cloud data, and proceeds to step S220. More specifically, data of the three-dimensional object or the like on the road RD is detected and separated from the point cloud data, and point cloud data indicating a flat road surface and point cloud data indicating the three-dimensional object or the like are obtained. The three-dimensional object or the like includes, for example, the first three-dimensional object, the second three-dimensional object, an obstacle on a road, a curbstone, a wall, a groove, a guardrail, and the like provided at the left and right ends of the road RD, and in addition, other vehicles such as a motorcycle that is traveling.

An example of the separation processing will be described. The processing unit 11 converts the coordinates of the relative position of the point cloud data with the position of the subject vehicle 101 as the center, indicates the road RD on the X-Y two-dimensional map corresponding to the depth direction and the road width direction, for example, as viewed from above, and forms the two-dimensional map into grids having a predetermined size. In a case where the difference between the maximum value and the minimum value of the data in the grid in each grid is smaller than a predetermined threshold, the processing unit 11 determines that the data of the grid indicates a flat road surface. On the other hand, in a case where the difference between the maximum value and the minimum value of the data in the grid is larger than the predetermined threshold, the processing unit 11 determines that the data of the grid indicates a three-dimensional object or the like.

Note that as a method of determining whether the point cloud data corresponds to the data of the road surface or the three-dimensional object or the like, another method may be used.

In step S220, the processing unit 11 determines whether processing target data is the data of the road surface. When the data is the data of the grid separated as the data of the road surface, the processing unit 11 makes an affirmative determination in step S220 and proceeds to step S230. On the other hand, when the data is the data of the grid separated as the data of the three-dimensional object or the like, the processing unit 11 makes a negative determination in step S220 and proceeds to step S250.

In the case of proceeding to step S250, the recognition unit 111 of the processing unit 11 converts the coordinates of the relative position of the three-dimensional object or the like based on the point cloud data of the grid with the position of the subject vehicle 101 as the center, and records the coordinates on the two-dimensional map. Then, the processing in FIG. 12 ends, and the processing proceeds to step S30 in FIG. 11A.

In the case of proceeding to step S230, the prediction unit 114 of the processing unit 11 calculates the road surface gradient of the road RD. An example of the road surface gradient calculation processing is as described with reference to FIGS. 3A to 3D. Note that as the road surface gradient calculation method, another method may be used.

In step S240, the prediction unit 114 of the processing unit 11 acquires the maximum depth distance L, ends the processing of FIG. 12, and proceeds to step S30 of FIG. 11A.

As described above, the maximum depth distance Lis the farthest depth distance that can be detected by the LiDAR 5. The prediction unit 114 of the processing unit 11 acquires, as the maximum depth distance L, the depth distance corresponding to the data of the grid farthest from the position of the subject vehicle 101 among the grids extracted at the time of the road surface gradient calculation processing.

According to the embodiment described above, the following operations and effects are obtained.

(1) The external environment recognition apparatus 50 includes: the LiDAR 5 as an in-vehicle detection unit that scans and emits electromagnetic waves in the horizontal direction and the vertical direction to acquire point cloud data including three-dimensional position information of detection points (a plurality of detection points in a matrix shape) on a surface of an object based on a reflected wave from the object around the subject vehicle 101 frame by frame, the recognition unit 111 that recognizes a three-dimensional object on the road RD on which the subject vehicle 101 travels as external environment information on the basis of the point cloud data for each frame, the first determination unit (determination unit 113) that determines an interval between the detection points in the vertical direction of the point cloud data of the next frame as the first angular resolution in the vertical direction for scanning and emitting the electromagnetic waves on the basis of a size in the vertical direction of the first three-dimensional object determined in advance as a detection target on a road apart from the subject vehicle 101 by the required depth distance N as a first distance based on a vehicle speed of the subject vehicle 101, the second determination unit (determination unit 113) that determines an interval between detection points in the vertical direction of the point cloud data of the next frame as the second angular resolution in the vertical direction for scanning and emitting the electromagnetic waves on the basis of a size in the vertical direction of the second three-dimensional object determined in advance as a detection target located at a predetermined height from a road surface apart from the subject vehicle 101 by a second distance, and the setting unit 112 as a control unit that controls scanning and emission of the LiDAR 5 with the interval between detection points in the vertical direction of the point cloud data of the next frame as the first angular resolution or the second angular resolution for each angle in the vertical direction.

In general, since the viewing angle with respect to the detection target increases as the depth distance X decreases, it is possible to detect the detection target even when the angular resolution is low. On the other hand, since the viewing angle with respect to the detection target decreases as the depth distance X increases, high angular resolution is required for detecting the detection target. In the embodiment, the LiDAR 5 acquires the depth distance X to the road surface of the road RD in the advancing direction for each detection point, and the first determination unit (determination unit 113) determines the angular resolution of the irradiation light corresponding to the interval of the detection points required for the recognition unit 111 to recognize the three-dimensional object at the depth distance X.

With this configuration, the interval of the detection points of the three-dimensional point cloud data used for the recognition processing by the recognition unit 111 is appropriately controlled, so that the total number of pieces of detection data used for the recognition processing can be suppressed. That is, the processing load of the processing unit 11 can be reduced without degrading the recognition accuracy of the position or the size of the first three-dimensional object to be a detection target of the external environment recognition apparatus 50.

In addition, in order to improve the safety of the subject vehicle 101, there is a case where it is desired to recognize the second three-dimensional object (for example, a traffic light SG, a traffic sign, or the like) in a space above the road surface in addition to recognizing the first three-dimensional object on the road. In the three-dimensional space above the road surface on the upper side of the FOV, the vertical direction angle becomes upward as the depth distance X becomes longer. In the embodiment, the gradient of the road RD in the advancing direction and the depth distance X are calculated, the distance DL to the second three-dimensional object is calculated for each angle in the vertical direction, and the second determination unit (the determination unit 113) determines the angular resolution in the vertical direction required for detecting the height of the second three-dimensional object at the distance DL.

By limiting the space in which the recognition unit 111 recognizes the second three-dimensional object above the road surface to the existence range of the second three-dimensional object (a range in which the second three-dimensional object can exist), the total number of pieces of detection data used for the recognition processing can be suppressed as compared with the case where the second three-dimensional object is recognized in the entire area of the space above the road surface. That is, the processing load of the processing unit 11 can be reduced without degrading the recognition accuracy of the position or the size of the second three-dimensional object to be a detection target of the external environment recognition apparatus 50.

Additionally, in a case where the LiDAR 5 is configured to be able to flexibly change the irradiation points (detection points) when scanning and emitting the laser light, the LiDAR 5 can be configured to be small and inexpensive, such as reducing the number of laser elements constituting the laser source.

Furthermore, in the embodiment, even when the subject vehicle 101 travels on the road RD that is not included in the high-precision map information, the road RD on which the subject vehicle 101 travels for the first time in a state in which the high-precision map information is not provided, and the road RD that changes to a situation different from the high-precision map information due to construction work or the like, it is possible to determine the angular resolution of the irradiation light corresponding to the interval of the detection points required for the recognition unit 111 to recognize the first three-dimensional object and the second three-dimensional object at each depth distance X while acquiring the depth distance X to the road surface of the road RD in the advancing direction for each detection point by using the LiDAR 5.

(2) In the external environment recognition apparatus 50, the setting unit 112 as a control unit controls the scanning irradiation by the LiDAR 5 with the higher one of the first angular resolution and the second angular resolution for the interval of the detection points in the vertical direction of the point cloud data of the next frame.

With this configuration, the processing load of the processing unit 11 can be reduced without degrading the recognition accuracy of the position or the size of the first three-dimensional object and the second three-dimensional object to be a detection target of the external environment recognition apparatus 50.

(3) In the external environment recognition apparatus 50, the first determination unit (determination unit 113) further makes the first angular resolution sparse as the scanning irradiation destination of the electromagnetic waves is farther from the subject vehicle 101 with respect to the required depth distance N as the first distance in the FOV of the LiDAR 5.

With this configuration, for example, while higher recognition accuracy is secured in an area corresponding to the required depth distance N, the recognition accuracy is lowered in an area of the sky on the upper side of the FOV and farther than the required depth distance N, and the total number of pieces of detection data used for the recognition processing by the recognition unit 111 can be suppressed.

(4) In the external environment recognition apparatus 50, the first determination unit (determination unit 113) further makes the first angular resolution sparse as the scanning irradiation destination of the electromagnetic waves is closer to the subject vehicle 101 with respect to the required depth distance N as the first distance in the FOV of the LiDAR 5.

With this configuration, for example, while higher recognition accuracy is secured in an area corresponding to the required depth distance N, the recognition accuracy is lowered in an area on the lower side of the FOV in the vicinity with respect to the required depth distance N (an area where the viewing angle with respect to the detection target is large) as compared with the vicinity of the required depth distance N, and the total number of pieces of detection data used for the recognition processing by the recognition unit 111 can be suppressed.

(5) In the external environment recognition apparatus 50, the second three-dimensional object is the traffic light SG.

With this configuration, in addition to recognizing the first three-dimensional object on the road, the traffic light SG as the second three-dimensional object can be recognized in the space above the road surface apart from the subject vehicle 101 by the second distance. When the traffic light SG can be recognized from the position apart by the second distance, it is possible to perform travel control of the subject vehicle 101 that is gentle to the occupant, such as low-impact deceleration without sudden braking.

The above-described embodiment can be modified in various manners. Hereinafter, modifications will be described.

### (First Modification)

The reflection intensity of the irradiation light by the LiDAR 5 is weak on a road surface far away from the subject vehicle 101, and reflected light with sufficient intensity may not be detected in some cases. The depth distance X in such a case where the reflection intensity on the road surface decreases to a barely detectable level also corresponds to the maximum depth distance L.

In the first modification, when the required depth distance N calculated from the vehicle speed of the subject vehicle 101 exceeds the maximum depth distance L (for example, when the required depth distance Nis 150 m, the maximum depth distance L=110 m), the prediction unit 114 described above may predict the height Z (gradient) of the road surface from the maximum depth distance L to the required depth distance N using the measurement data practically acquired by the LiDAR 5 from the depth distance corresponding to the lower end of the FOV to the maximum depth distance L. For the prediction of the gradient, the above-described ARIMA model or the like can be used.

According to the first modification, even in a situation in which it is difficult to detect the road surface itself depending on the state of the road surface, it becomes possible to detect irregularities of the road surface, three-dimensional objects, or the like, which have a level of reflected light higher than that of the reflected light on the road surface as appropriate when acquiring the three-dimensional point cloud data of the next frame.

### (Second Modification)

In the above-described embodiment, the example in which the external environment recognition apparatus 50 causes the LiDAR 5 to detect the road surface situation in the advancing direction of the subject vehicle 101 has been described. Instead of this, for example, the LiDAR 5 having an FOV in which 360 deg is detectable in the surroundings of the subject vehicle 101 may be provided, and the LiDAR 5 may be configured to detect the road surface situation of the entire surroundings of the subject vehicle 101.

The above embodiment can be combined as desired with one or more of the above modifications. The modifications can also be combined with one another.

According to the present invention, it is possible to reduce the load of processing of recognizing the external environment situation around the vehicle.

Above, while the present invention has been described with reference to the preferred embodiments thereof, it will be understood, by those skilled in the art, that various changes and modifications may be made thereto without departing from the scope of the appended claims.

What is claimed is:

1. An external environment recognition apparatus comprising:
an in-vehicle detection unit configured to scan and emit electromagnetic waves in a horizontal direction and a vertical direction to acquire point cloud data including three-dimensional position information of detection points on a surface of an object based on a reflected wave from the object around a subject vehicle frame by frame; and
a microprocessor, wherein
the microprocessor is configured to perform:
recognizing a three-dimensional object on a road on which the subject vehicle travels based on the point cloud data for each frame;
determining an interval between detection points in the vertical direction of the point cloud data of a next frame as a first angular resolution in the vertical direction for scanning and emitting the electromagnetic waves based on a size in the vertical direction of a first three-dimensional object determined in advance as a detection target on a road apart from the subject vehicle by a first distance based on a vehicle speed of the subject vehicle;
determining the interval between the detection points in the vertical direction of the point cloud data of the next frame as a second angular resolution in the vertical direction for scanning and emitting the electromagnetic waves based on a size in the vertical direction of a second three-dimensional object determined in advance as a detection target located at a predetermined height from a road surface apart from the subject vehicle by a second distance; and
controlling scanning and emission of the in-vehicle detection unit with the interval between detection points in the vertical direction of the point cloud data of the next frame as the first angular resolution or the second angular resolution for each angle in the vertical direction.

2. The external environment recognition apparatus according to claim 1, wherein
the microprocessor is configured to perform
the controlling including controlling a scanning irradiation by the in-vehicle detection unit with the higher one of the first angular resolution and the second angular resolution for the interval of the detection points in the vertical direction of the point cloud data of the next frame.

3. The external environment recognition apparatus according to claim 2, wherein
the microprocessor is configured to perform
the determining for the first angular resolution including making the first angular resolution sparse as a scanning irradiation destination of the electromagnetic waves is farther from the subject vehicle with respect to the first distance in a field of view of the in-vehicle detection unit.

4. The external environment recognition apparatus according to claim 3, wherein
the microprocessor is configured to perform
the determining for the first angular resolution including making the first angular resolution sparse as the scanning irradiation destination of the electromagnetic waves is closer to the subject vehicle with respect to the first distance in the field of view of the in-vehicle detection unit.

5. The external environment recognition apparatus according to claim 1, wherein
the second three-dimensional object is a traffic light.

6. The external environment recognition apparatus according to claim 1, wherein
the in-vehicle detection unit is a LiDAR.
